(19) United States
(12) Patent Application Publication
(10) Pub. No.: US 2016/0295646 A1
(43) Pub. Date: Oct. 6, 2016

(54) EMOTIONAL LIGHTING DEVICE AND CONTROL METHOD THEREFOR

(71) Applicant: Gu LIM, Seoul (KR)

(72) Inventor: Gu LIM, Seoul (KR)

(21) Appl. No.: 15/038,448

(22) PCT Filed: Nov. 19, 2014
(86) PCT No.: PCT/KR2014/011113

§ 371 Date: May 20, 2016

(30) Foreign Application Priority Data
Nov. 20, 2013 (KR) 10-2013-0141497

(51) Int. Cl. H05B 33/08; H05B 37/02

(52) U.S. Cl. CPC H05B 33/086; H05B 37/0272

(57) ABSTRACT

The purpose of the present invention is to provide an emotional lighting device and a control method therefor, the emotional lighting device providing optimized lighting by controlling color temperatures of lighting by compensating for a time difference between a current position and a change in the current position. As such, the present invention can provide optimized lighting.

### TECHNICAL FIELD

The present invention relates to an emotional lighting device, and a control method thereof, and in particular to an emotional lighting device and a control method thereof which are able to provide the optimized lighting by providing a color temperature control in such a way to compensate a time difference between the current position and any change to the current position.

### BACKGROUND ART

In recent years, as a current residential environment is developed, an indoor lighting is being currently changed from a white lighting which uses, for example, a fluorescent lamp, a halogen lamp, etc., to an advanced interior lighting which can be carried out in such a way to variously express an indoor lighting color, namely, a color temperature.

As one of the most representative lighting equipment for the aforementioned advanced interior lighting, there is a lighting device which uses as a light source an LED (Light Emitting Diode) the application of which is continuously increasing.

For reference, the color temperature may be a means to express the light of a light source in numeric forms. As for the color temperature, if an ideal black body is heated, a dark red color may turn into an orange color, a yellow color, and a white heat color, and if the temperature increases, it may emit a blue light. The color combination may be expressed in the form of absolute temperature, more specifically, it can be expressed with the unit of Kelvin (K).

Moreover, the LED is an element which, in general, is compact-sized and has a good efficiency and is able to emit clear color lights. Since it is a semiconductor element, there is no need to worry about any damage thereto, and an initial driving characteristic and anti-shock performance are good, and it provides a good performance at a repeated operation, for example, an ON/OFF lighting, etc.

The lighting device manufactured using such a LED, mainly, is used for a main lamp device, a desk-mounted stand lamp, etc. in a room or an office. As a more advanced application based on the aforementioned application, there is a lighting tile which can be manufactured using a light guide plate.

The aforementioned lighting device may be configured in such a way that a LED module wherein a plurality of LEDs are mounted, is provided multiple in number at a predetermined array structure, and the LED module is installed on a ceiling or a wall surface of a predetermined space.

The Korean patent laid-open No. 10-2011-22980 (the title of the invention: device and method for controlling an emotional lighting using a weather and time information) describes a device and method for controlling an emotional lighting using a weather and time information, wherein a weather information and a time information are received from an information providing server, and a lighting device and a home network device, for example, a plurality of electronic devices, can be controlled using the received weather and time information based on an emotional lighting scenario, thus actively expressing an emotional lighting.

The aforementioned emotional lighting device, however, is able to control lighting devices using a previously set parameter based on the detected scenario as long as the weather information and time information are simply detected. If the position of the lighting device is changed or the time information is changed, it is impossible to provide a set lighting.

Moreover, the conventional lighting device is configured to operate with a constant brightness set based on a previously set lighting scenario and provide a lighting irrespective of the current position and time of a user, for which it is impossible to provide a natural light which is similar to an outdoor environment when the weather is clean.

Furthermore, the conventional lighting device can be employed only for the sake of an indoor space. It cannot be actually employed at a transportation means, which moves a long distance, for example, a bus, a train, an airplane, a ship, etc. due to a time difference which may occur owing to the long distance movement, which means that the conventional lighting device is not good at improving any inconvenience caused for the aforementioned reasons.

### SUMMARY OF THE DISCLOSURE

### Technical Problem

The present invention has been made in an effort to solve the above-described problems associated with prior art. It is an object of the present invention to provide an emotional lighting device and a control method thereof which are able to provide the optimized lighting by controlling a color temperature of lighting in such a way to compensate a time difference between the current position and any change to the current position.

### Technical Solution

To achieve the above object, there is provided an emotional lighting device, which may include, but is not limited to, a lighting device wherein a current position information and a standard time information are received from a satellite, and a color temperature control signal of a previously set lighting is outputted, and the current position information and the standard time information are updated at regular time intervals, and as a result of the update, if the current position has changed, it is judged if the standard time has changed at the changed current position, and if the standard time has changed, a color temperature of a lighting on which a time difference due to the position change has been reflected, is controlled to be changed.

In addition, the lighting device may include, but is not limited to, a satellite signal receiving unit which is employed to receive a satellite signal including the current position information and the standard time information from the satellite; a control unit which is employed to detect the current position information and the standard time information by analyzing the satellite signal that the satellite signal receiving unit has received, and search for a color temperature information of the lighting set based on the detected current position information and standard time information, and output a color temperature control signal; and a light source unit which is employed to emit a light in accordance with a color temperature control signal outputted from the control unit.

Moreover, the satellite signal receiving unit may include, but is not limited to, a GPS signal detecting unit which is employed to detect a GPS signal from the received satellite signal and output the detected GPS signal; and a standard time detecting unit which is employed to detect a standard time information from the received satellite signal and output the detected standard time information.

Furthermore, the control unit may include, but is not limited to, a position analysis unit which is employed to detect a longitude of a current position from a GPS signal outputted from the satellite signal receiving unit and detect a standard time information of the current position corresponding to the longitude detected from the standard time information; and a color temperature control unit which is employed to search for a color temperature control information on which the current position detected by the position analysis unit, and a standard time, a season, a day time, a night time, and a sunrise and sunset information have been reflected and output the searched color temperature control signal to the light source unit.

In addition, the position analysis unit is employed to determine if the standard time of the set current position has changed by analyzing an angle difference between the longitude of the detected current position and the prime meridian.

Moreover, the color temperature control unit is employed to output a control signal to maintain a low color temperature from a sunset to a sunrise, output a control signal for the color temperature to sequentially change from a low color temperature to a high color temperature in the morning, output a control signal to maintain a high color temperature at noon, and output a control signal for the color temperature to sequentially change from a high color temperature to a low color temperature from a noon to a sunset.

Furthermore, the light source unit may include, but is not limited to, a first LED module which is employed to emit a warm white light of a low color temperature; and a second LED module which is employed to emit a cool white light of a high color temperature.

In addition, the lighting device is installed at any of a building and a transportation means and is able to output a color temperature control signal of lighting based on a current position information and a standard time information.

To achieve the above objects, there is provided a method for controlling an emotional lighting device, which may include, but is not limited to, (a) a step wherein if a light turning-on signal is inputted, a control unit receives, via a satellite signal receiving unit, a satellite signal including a current position information and a standard time information of the current position from a satellite; (b) a step wherein if the satellite signal is received, the control unit detects a current position information and a standard time information by analyzing the received satellite signal and searches for a color temperature information set based on the current position and the standard time and outputs a color temperature control signal of lighting to a light source unit; (c) a step wherein the control unit judges if the current position has changed by updating the current position information and the standard time information via the satellite signal receiving unit; (d) a step wherein if the current position has not changed as a result of the judgment in the step (c), the control unit outputs a color temperature control signal set in the step (b), and if the current position has changed, the control unit judges if the standard time at the changed current position has changed; and (e) a step wherein if the standard time has not changed as a result of the judgment in the step (d), the control unit outputs a color temperature control signal set in the step (b), and if the standard time has changed, the control unit controls the light source unit to change a color temperature of lighting on which the time difference due to the position change has been reflected.

Moreover, the standard time change state in the step (d) is determined based on an angle difference between the longitude at the current position and the prime meridian.

### Advantageous Effects

The present invention is able to provide the optimized lighting by controlling a color temperature in such a way to compensate a time difference between the current position and any change to the current position.

Moreover, the present invention is able to reduce any non-adaptation which might occur due to a time difference during a long distance movement with the aid of a lighting control for which a time difference due to a position change has been compensated.

### BRIEF DESCRIPTION OF THE DRAWINGS

FIG. 1 is a block diagram illustrating an emotional lighting device according to an embodiment of the present invention;

FIG. 2 is a block diagram illustrating the configuration of an emotional lighting device according to the present invention; and

FIG. 3 is a flow chart for describing a control method of an emotional lighting according to the present invention.

### DETAILED DESCRIPTION

The preferred embodiments of the emotional lighting device and control method thereof according to a preferred embodiment of the present invention will be described with reference to the accompanying drawings.

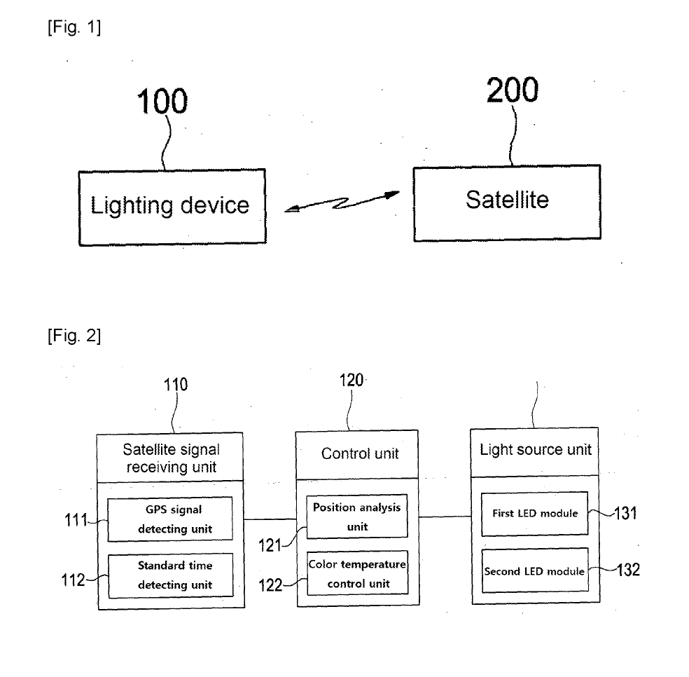

FIG. 1 is a block diagram illustrating an emotional lighting device according to an embodiment of the present invention, and FIG. 2 is a block diagram illustrating the configuration of an emotional lighting device according to the present invention.

As illustrated in FIGS. 1 and 2, the emotional lighting device 100 may include, but is not limited to, a satellite signal receiving unit 110, a control unit 120, and a light source unit 130, wherein in order to provide the optimum lighting by controlling a color temperature in such a way to compensate a time difference between the current position and any change to the current position, a current position information and a standard time information are received from a satellite 200, and a color temperature control signal of a previously set lighting is outputted, and the current position information and the standard time information are updated at a predetermined time interval, and if the current position has been changed, any change to the standard time at the current position is judged, and if the standard time is changed, the color temperature of the lighting is controlled to be changed by reflecting a time difference due to the position change.

Moreover, the lighting device 100 may be installed at the inside or outside of a building or at a transportation means, for example, a vehicle, a bus, an airplane, a ship, etc., thus outputting a color temperature control signal of lighting based on a current position information and a standard time information at the current position.

The satellite signal receiving unit 110 is employed to receive a satellite signal including a current position information and a standard time information from a plurality of satellites 200 and output to the control unit 120 and may include a GPS (Global Positioning System) signal detecting unit 111, and a standard time detecting unit 112.

The GPS signal detecting unit 111 is able to detect a GPS signal in a satellite signal received from a plurality of the satellites 200, thus outputting a coordinate value. It may calculate and output a current position information.

The standard time detecting unit 112 is employed to detect and output a standard time information in the received satellite signal and provide a time at the current position.

The control unit 120 is employed to detect a current position information and a standard time information by analyzing the satellite signal that the satellite signal receiving unit 110 has received, and search for a color temperature information of lighting which has been set based on the detected current position information and standard time information and output a color temperature control signal and may include a position analysis unit 121, and a color temperature control unit 122.

The position analysis unit 121 is employed to detect a longitude and a latitude which correspond to the current position from the GPS signal outputted from the satellite signal receiving unit 110 and detect a standard time information of the current position corresponding to the longitude and latitude detected from the standard time information.

Moreover, the position analysis unit 121 is able to determine any change to the standard time of the currently set position by analyzing any angle difference between the longitude of the detected current position and the prime meridian.

More specifically, a date will change between the east and the west about the International Date Line which is set north and south along the longitude of 180° almost in the center of the Pacific Ocean. The average solar time is exclusive at every point of the globe, for which a time difference may occur between the points which are located over the east and the west. The time will pass one hour earlier in the direction of east at every 15° longitude.

For example, 0 hour on the 1^{st} date of January based on the Korean Standard Time (the average solar time of Tokyo 135°) corresponds to 1 o'clock on the 1^{st} date at the Tokyo 150° and 2 o'clock on the 1^{st} date at 165°, and if moving continuously in the direction of east, it will be 15 o'clock on the 1^{st} date at the Greenwich, and if moving continuously in the direction of east, it will be 23 o'clock on the 1^{st} date at the Tokyo 120°. For this reason, in case of the use of a transportation means, for example, an airplane, a time difference may inevitably occur due to the positions.

The position analysis unit 121 is able to periodically update the current position information at every time interval so as to reflect such a time difference based on the positions and judge if a time difference occurs, in such a way to compare the updated current position to a reference position, for example, the International Date Line or the prime meridian. As a result of the judgment, if a time change is not necessary, the position analysis unit 121 will allow the currently set time information to be outputted as a standard time information, and if the time change is necessary, the position analysis unit 121 will allow the changed time information to be outputted as a standard time information by adding or subtracting one hour to/from the currently set time information.

The color temperature control unit 122 may be configured to search for a color temperature control information on which the current position based on the longitude and latitude detected by the position analysis unit 121, and a standard time, a season, a day time, a night time, and sunrise and sunset information at the current position have been reflected, and the searched color temperature control signal may be outputted to the light source unit 130. The color temperature control unit 122 may include a storing unit which is able to store a color temperature control information on which the current position, and a standard time, a season, a day time, a night time, and sunrise and sunset information at the current position have been reflected.

Moreover, the color temperature control unit 122 is employed to output a control signal which controls a warm white light of a low color temperature to be outputted so as to maintain a low color temperature from a sunset to a sunrise, and output a control signal which controls the color temperature to gradually change from a low color temperature to a high color temperature in the morning, and output a control signal which controls a cool white light of a high color temperature to be outputted so as to maintain a high color temperature at noon, and output a control signal which controls the color temperature to gradually change from a high color temperature to a low color temperature from a noon and to a sunset.

More specifically, the light source unit 130 may output a color temperature control signal to maintain a color temperature at about 2500K-3000K by turning on only the warm white light from a sunset to a sunrise, increase the color temperature up to about 4500K-5000K by adjusting the warm white light and the cool white light of the light source unit 130 from a sunrise to the morning time, maintain the color temperature at about 7000K-8000K at a noon by turning on only the cool white light, and decrease the color temperature to about 4500K-5000K by adjusting the warm white light and the cool white light of the light source unit 130 from a noon to a sunset.

The light source unit 130 is configured to emit a light in response to a color temperature control signal outputted from the control unit 120 and may include a first LED module 131 which is able to emit a warm white light of a low color temperature, and a second LED module 132 which is able to emit a cool white light of a high color temperature.

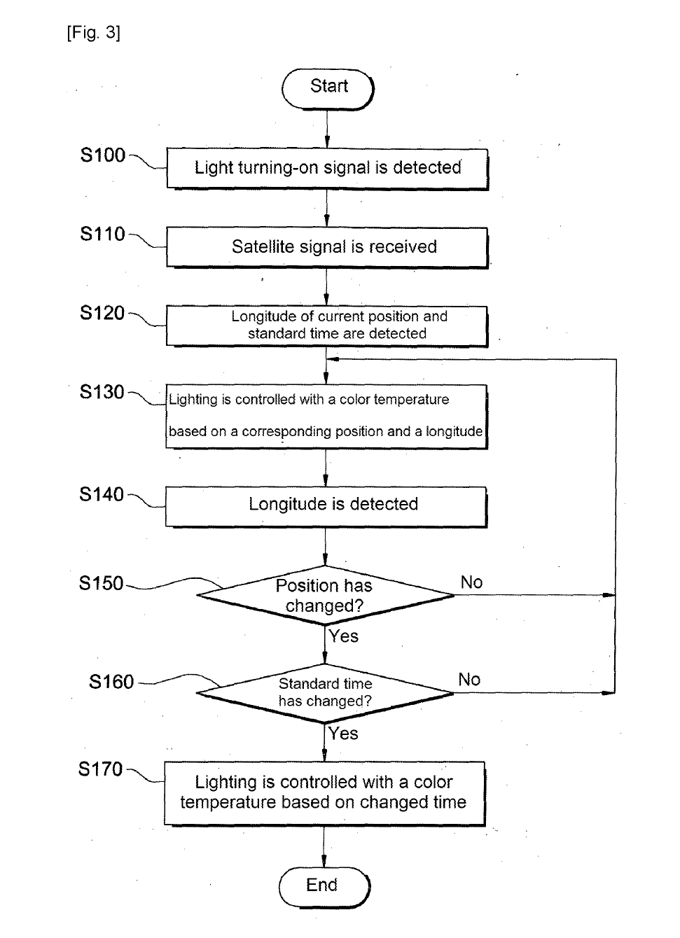

FIG. 3 is a flow chart for describing a method for controlling an emotional lighting according to the present invention. The method for controlling an emotional lighting according to the present invention will be described with reference to the accompanying drawings.

If a light turning-on signal is inputted (S100), the control unit 120 may receive a satellite signal including a current position information and a standard time information of the current position from a plurality of the satellites 200 via the satellite signal receiving unit 110 (S110).

If the satellite signal in the step S110 is received, the control unit 120 may detect a current position information and a standard time information by analyzing the received satellite signal (S120) and may search from a storing unit, for example, a memory, a color temperature information set based on the current position and the standard time and may output a color temperature control signal of lighting to the light source unit 130 (S130).

The control unit 120 may detect the longitude of the current position by updating the current position information and the standard time information with the aid of the satellite signal receiving unit 110 at regular intervals (S140) and may compare the thusly detected longitude to the longitude detected in the step S120, thus judging if the current position has changed (S150).

If there is not any change to the current position since the longitude detected at the step S120 is same as the longitude detected at the step S140 as a result of the judgment at the step S150, the control unit 120 may maintain the output of the color temperature control signal set at the step S130, and if there is any change at the current position since the longitude detected at the step S120 is not same as the longitude detected at the step S140, the control unit 120 may judge if the currently set standard time has changed by analyzing any angle difference between the longitude at the changed current position and the prime meridian (S160).

If the longitude detected at the step S140 is in an angle range wherein the time change is not necessary, as a result of the judgment at the step S160, the control unit 120 may maintain the output of a color temperature control signal set at the step S130 without any change to the standard time, and if the longitude detected at the step S140 is in an angle or an angle range wherein the time change is not necessary, the control unit 120 may output a color temperature control signal to the light source unit 130 for the color temperature of lighting to be changed (S170), wherein the time difference based on the position change has been reflected on the color temperature thereof.

If a time difference occurs between a start position and an arrival position, a color temperature control signal is outputted to the light source unit, wherein the time difference has been reflected on the color temperature control signal based on the current position on the passage which moves matching with the standard time of the arrival position during the movement, whereby any fatigue due to the time difference between the night time and the day time can be reduced with the aid of the lighting device.

While the present invention has been described with reference to the preferred embodiments, it should be understood that a person having ordinary skill in the art is able to variously modify and change the present invention without departing from the concept and scope of the present invention recited in the accompanying claims.

Moreover, the thickness of the lines drawn in the drawings and the sizes of components throughout the descriptions on the embodiments of the present invention may be expressed exaggerated for the sake of clear and convenient descriptions, and the terms used throughout the descriptions are defined based on the functions thereof. The aforementioned terms may change in accordance with a user's or operator's intention or practice. In this case, such terms should be defined based on the whole contents of the specification.

### LEGEND OF REFERENCE NUMERALS

100: Lighting device
110: Satellite signal receiving unit
111: GPS signal detecting unit
112: Standard time detecting unit
120: Control unit
121: Position analysis unit
122: Color temperature control unit
130: Light source unit
131: First LED module
132: Second LED module
200: Satellite

What is claimed is:

1. An emotional lighting device, comprising:
a lighting device 100 wherein a current position information and a standard time information are received from a satellite 200, and a color temperature control signal of a previously set lighting is outputted, and the current position information and the standard time information are updated at regular time intervals, and as a result of the update, if the current position has changed, it is judged if the standard time has changed at the changed current position, and if the standard time has changed, a color temperature of a lighting on which a time difference due to the position change has been reflected, is controlled to be changed.

2. The device of claim 1, wherein the lighting device 100 comprises:
a satellite signal receiving unit 110 which is employed to receive a satellite signal including the current position information and the standard time information from the satellite 200;
a control unit 120 which is employed to detect the current position information and the standard time information by analyzing the satellite signal that the satellite signal receiving unit 110 has received, and search for a color temperature information of the lighting set based on the detected current position information and standard time information, and output a color temperature control signal; and
a light source unit 130 which is employed to emit a light in accordance with a color temperature control signal outputted from the control unit 120.

3. The device of claim 2, wherein the satellite signal receiving unit 110 comprises:
a GPS signal detecting unit 111 which is employed to detect a GPS signal from the received satellite signal and output the detected GPS signal; and
a standard time detecting unit 112 which is employed to detect a standard time information from the received satellite signal and output the detected standard time information.

4. The device of claim 2, wherein the control unit 120 comprises:
a position analysis unit 121 which is employed to detect a longitude of a current position from a GPS signal outputted from the satellite signal receiving unit 110 and detect a standard time information of the current position corresponding to the longitude detected from the standard time information; and
a color temperature control unit 122 which is employed to search for a color temperature control information on which the current position detected by the position analysis unit 121, and a standard time, a season, a day time, a night time, and a sunrise and sunset information have been reflected and output the searched color temperature control signal to the light source unit 130.

5. The device of claim 4, wherein the position analysis unit 121 is employed to determine if the standard time of the set current position has changed by analyzing an angle difference between the longitude of the detected current position and the prime meridian.

6. The device of claim 4, wherein the color temperature control unit 122 is employed to output a control signal to maintain a low color temperature from a sunset to a sunrise, output a control signal for the color temperature to sequentially change from a low color temperature to a high color temperature in the morning, output a control signal to maintain a high color temperature at noon, and output a control signal for the color temperature to sequentially change from a high color temperature to a low color temperature from a noon to a sunset.

7. The device of claim 2, wherein the light source unit 130 comprises:
a first LED module 131 which is employed to emit a warm white light of a low color temperature; and
a second LED module 132 which is employed to emit a cool white light of a high color temperature.

8. The device of any of claims 1 to 7, wherein the lighting device 100 is installed at any of a building and a transportation means and is able to output a color temperature control signal of lighting based on a current position information and a standard time information.

9. A method for controlling an emotional lighting device, comprising:
(a) a step wherein if a light turning-on signal is inputted, a control unit 120 receives, via a satellite signal receiving unit 110, a satellite signal including a current position information and a standard time information of the current position from a satellite 200;
(b) a step wherein if the satellite signal is received, the control unit 120 detects a current position information and a standard time information by analyzing the received satellite signal and searches for a color temperature information set based on the current position and the standard time and outputs a color temperature control signal of lighting to a light source unit 130;
(c) a step wherein the control unit 120 judges if the current position has changed by updating the current position information and the standard time information via the satellite signal receiving unit 110;
(d) a step wherein if the current position has not changed as a result of the judgment in the step (c), the control unit 120 outputs a color temperature control signal set in the step (b), and if the current position has changed, the control unit 120 judges if the standard time at the changed current position has changed; and
(e) a step wherein if the standard time has not changed as a result of the judgment in the step (d), the control unit 120 outputs a color temperature control signal set in the step (b), and if the standard time has changed, the control unit 120 controls the light source unit 130 to change a color temperature of lighting on which the time difference due to the position change has been reflected.

10. The method of claim 9, wherein the standard time change state in the step (d) is determined based on an angle difference between the longitude at the current position and the prime meridian.
